(19) United States
(12) Patent Application Publication
(10) Pub. No.: US 2025/0139285 A1
(43) Pub. Date: May 1, 2025

(54) MONITORING SYSTEM, COMMUNICATION APPARATUS, MONITORING METHOD, AND NON-TRANSITORY COMPUTER READABLE MEDIUM

(71) Applicant: NEC Corporation, Minato- ku, Tokyo (JP)

(72) Inventor: Shigeo YOSHIDA, Tokyo (JP)

(73) Assignee: NEC Corporation, Minato- ku, Tokyo (JP)

(21) Appl. No.: 18/835,835

(22) PCT Filed: Feb. 22, 2022
(86) PCT No.: PCT/JP2022/007273

§ 371 Date: Aug. 5, 2024

(51) Int. Cl. G06F 21/62; G06F 21/84

(52) U.S. Cl. CPC G06F 21/6245; G06F 21/84

(57) ABSTRACT

An object of the present disclosure is to provide a monitoring system capable of achieving efficient and robust security in an environment in which there are files of various importance levels. The monitoring system according to the present disclosure includes: reception means (11) for receiving an instruction to access an instruction to access data including confidential information and identification information that is used to identify a user who uses the data; display means (12) for displaying data when the input identification information on the user matches identification information associated with a user who is permitted to view the data; and execution means (13) for executing security processing in accordance with the confidential level associated with the data in advance while the data is being displayed on the display means (12).

### TECHNICAL FIELD

The present disclosure relates to a monitoring system, a communication apparatus, a monitoring method, and a non-transitory computer readable medium.

### BACKGROUND ART

In recent years, telecommuting, which enables workers to access data in a company from a place outside the company and view data managed inside the company, has become widespread. Since there is a possibility that the data within the company may leak out via computer apparatuses used by workers, it has been required to improve security. In particular, there is a concern that in-house data could be leaked to a third party who peeks into a computer apparatus of a worker viewing the in-house data from a place outside the company and grasps the content of this data.

Patent Literature 1 discloses a configuration of a peeking prevention system for activating a camera when a specific file is accessed and then determining whether or not there is a person who is peeking into a computer. The peeking prevention system disclosed in Patent Literature 1 determines, when a face image captured by a camera is different from a face image registered in advance, that an abnormal state is occurring and stops any further displaying of the information being displayed on the display screen or displays a popup screen indicating a warning.

### CITATION LIST

### Patent Literature

[Patent Literature 1] Japanese Unexamined Patent Application Publication No. 2017-117155

### SUMMARY OF INVENTION

### Technical Problem

The peeking prevention system in Patent Literature 1 discloses regularly activating a camera, capturing an image near the computer, and determining whether or not there is a person who is peeking into the computer. However, when access to a file whose importance level is high is monitored, the frequency of the activating of the camera may be low. Further, when access to a file whose importance level is low is monitored, a predetermined frequency of the activating of the camera may be too high. Therefore, there is a problem that the peeking prevention system disclosed in Patent Literature 1 cannot achieve efficient and robust security in an environment in which there are files of various importance levels.

One object of the present disclosure is to provide a monitoring system, a communication apparatus, a monitoring method, and a non-transitory computer readable medium capable of achieving efficient and robust security in an environment in which there are files of various importance levels.

### Solution to Problem

A monitoring system according to a first aspect of the present disclosure includes: reception means for receiving an instruction to access data including confidential information and identification information that is used to identify a user who uses the data: display means for displaying the data when the input identification information on the user matches identification information associated with a user who is permitted to view the data: and execution means for performing security processing in accordance with a confidential level associated with the data in advance while the data is being displayed on the display means.

A communication apparatus according to a second aspect of the present disclosure includes: reception means for receiving an instruction to access data and identification information that is used to identify a user who uses the data: determination means for determining whether or not the data is confidential information: display means for displaying the data when it is determined that the data is the identification information and the identification information matches identification information associated with the user who is permitted to view the data: and execution means for performing security processing in accordance with a confidential level associated with the data in advance while the data is being displayed.

A monitoring method according to a third aspect of the present disclosure includes: receiving an instruction to access data: determining whether or not the data is confidential information: receiving, in a case where the data is the confidential information, identification information for identifying a user who uses the data: displaying the data in a case where the input identification information on the user matches identification information associated with a user who is allowed to view the data: and performing security processing in accordance with a confidential level associated with the data in advance while the data is being displayed.

A program according to a fourth aspect of the present disclosure causes a computer to execute: receiving an instruction to access data: determining whether or not the data is confidential information: receiving, in a case where the data is the confidential information, identification information for identifying a user who uses the data; displaying the data in a case where the input identification information on the user matches identification information associated with a user who is allowed to view the data: and performing security processing in accordance with a confidential level associated with the data in advance while the data is being displayed.

### Advantageous Effects of Invention

According to the present disclosure, it is possible to provide a monitoring system, a communication apparatus, a monitoring method, and a non-transitory computer readable medium capable of achieving efficient and robust security in an environment in which there are files of various importance levels.

### BRIEF DESCRIPTION OF DRAWINGS

FIG. 1 is a configuration diagram of a management system according to a first example embodiment:

FIG. 2 is a configuration diagram of a management system according to a second example embodiment:

FIG. 3 is a configuration diagram of a management server according to the second example embodiment:

FIG. 4 is a diagram showing information regarding confidential information according to the second example embodiment:

FIG. 5 is a configuration diagram of an information terminal according to the second example embodiment:

FIG. 6 is a diagram showing a timing when a warning message is output to a display apparatus according to the second example embodiment:

FIG. 7 is a diagram showing association between confidential levels and warning numbers according to the second example embodiment;

FIG. 8 is a configuration diagram of a remote operation terminal according to the second example embodiment:

FIG. 9 is a diagram showing a flow of processing for registering information regarding the confidential information in the management server according to the second example embodiment:

FIG. 10 is a diagram showing a flow of processing for concealing a screen including confidential data according to the second example embodiment:

FIG. 11 is a diagram showing a flow of processing for outputting the warning message according to the second example embodiment: and

FIG. 12 is a configuration diagram of a management server, an information terminal, and a remote operation terminal according to each example embodiment.

### EXAMPLE EMBODIMENT

### First Example Embodiment

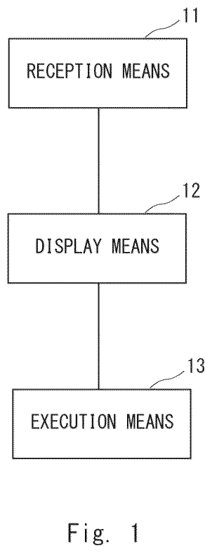

Hereinafter, with reference to the drawings, example embodiments of the present disclosure will be described. With reference to FIG. 1, a configuration example of a monitoring system according to a first example embodiment will be described. The monitoring system shown in FIG. 1 includes reception means 11, display means 12, and execution means 13. The reception means 11, the display means 12, and the execution means 13 may be software or modules whose processing is executed by a processor executing a program stored in a memory. Alternatively, the reception means 11, the display means 12, and the execution means 13 may each be hardware such as a circuit or a chip.

The reception means 11, the display means 12, and the execution means 13 are provided in a computer apparatus. The reception means 11, the display means 12, and the execution means 13 may be included in computer apparatuses different from each other or may be provided in one computer apparatus. Alternatively, two or more elements of the reception means 11, the display means 12, and the execution means 13 may be provided in one computer apparatus. The computer apparatus is an apparatus that operates by the processor executing the program stored in the memory.

The reception means 11 receives an instruction to access data including confidential information and identification information that is used to identify a user who uses the data. The reception means 11 receives, for example, the access instruction and the identification information that the user has input via an input interface. The input interface may be, for example, a keyboard, a touch panel or the like. Alternatively, the input interface may be a microphone that uses a voice. The confidential information may be, for example, information that can be viewed by only a limited number of users. The access instruction may be information indicating a path to an area where the data is stored or may be address information such as a Uniform Resource Locator (URL). The identification information, which is information with which the user can be uniquely identified, may be information indicating an Identifier (ID) or information indicating a password.

The display means 12 displays data when the input identification information of the user matches identification information associated with a user who is permitted to view the data. The identification information for identifying the user who is permitted to view the data may be associated with the data including the confidential information in advance. The identification information associated with the data including the confidential information may be stored in a memory or the like in the computer apparatus. The display means 12 may be, for example, a display apparatus that includes a display.

The execution means 13 performs security processing in accordance with the confidential level associated with the data in advance while the data is being displayed on the display means 12. The confidential level may be referred to as, for example, the importance level indicating the importance level of the data. The confidential level may be indicated, for example, by a numerical value. In this case, the larger the value is, the higher the confidential level or the importance level may be, and the smaller the value is, the lower the confidential level or the importance level may be. The confidential level associated with the data including the confidential information may be stored in a memory or the like in a computer apparatus.

The security processing may be referred to as a warning operation, and may be, for example, output of a warning message. The warning message, which is a message for warning that there is a person who is peeking into the data, may be displayed, for example, on a display apparatus such as a display or may be output via a speaker or the like as a voice. Alternatively, the security processing may be processing for warning a user by vibration. The security processing in accordance with the confidential level may be, for example, processing for increasing the frequency of the warning message being output as the confidential level becomes higher.

As described above, the monitoring system according to the first example embodiment executes security processing in accordance with the confidential level of data that the user accesses. Accordingly, even in an environment where there are data pieces with different levels of confidentiality or importance as well, it is possible to achieve efficient and robust security by adjusting the frequency of the warning message being output.

### Second Example Embodiment

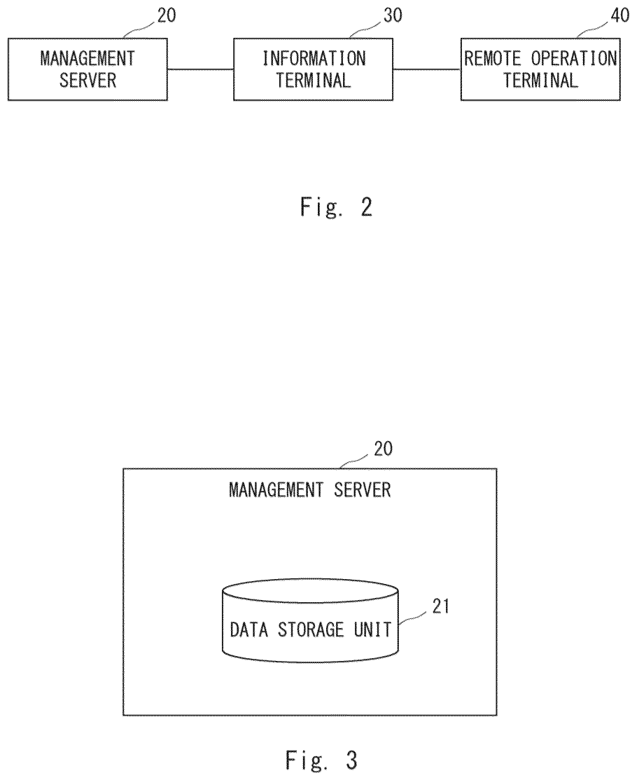

Next, with reference to FIG. 2, a configuration example of a monitoring system according to a second example embodiment will be described. The monitoring system shown in FIG. 2 includes a management server 20, an information terminal 30, and a remote operation terminal 40. The management server 20, the information terminal 30, and the remote operation terminal 40 may each be a computer apparatus. The information terminal 30 and the remote operation terminal 40 may be referred to as a communication apparatus that performs communication via a network. The remote operation terminal 40 accesses the information terminal 30 via a network and remotely operates the information terminal 30. Further, the information terminal 30 acquires data stored in the management server 20 by the remote operation performed by the remote operation terminal 40. The remote operation terminal 40 views the data acquired by the information terminal 30. The remote operation terminal 40 may acquire, for example, the data acquired by the information terminal 30, or may view the data acquired by the information terminal 30 by sharing the screen image displayed on the information terminal 30.

The information terminal 30 is, for example, a terminal that is installed in a company that manages the management server 20, and the remote operation terminal 40 may be a terminal installed outside the company. Therefore, the remote operation terminal 40 may be operated in an environment in which there is a person who is not authorized to view the data stored in the management server 20.

Alternatively, the information terminal 30 may acquire data from a server connected via, for example, the Internet by the remote operation performed by the remote operation terminal 40. In this case, the information terminal 30 acquires data from the server by accessing the specified URL.

Next, with reference to FIG. 3, a configuration example of the management server 20 according to the second example embodiment will be described. The management server 20 includes a data storage unit 21. The data storage unit 21 may be a memory built into the management server 20 or may be a memory externally attached to the management server 20.

The data storage unit 21 includes a plurality of files. Further, the data storage unit 21 stores information indicating whether or not each file includes confidential information. Further, the data storage unit 21 may store address information, which is the access destination to the server holding the data including the confidential information. The server indicated in the access destination is different from the management server 20. The address information may be URL.

The management server 20 transmits the file stored in the data storage unit 21 to the information terminal 30 in accordance with access made by the information terminal 30. That is, when the management server 20 receives a request message for requesting for the file from the information terminal 30, the management server 20 transmits a response message including the file specified in the request message to the information terminal 30. When the file specified in the request message includes confidential information, the management server 20 may include, in the response message, information indicating that the file includes the confidential information along with the file.

Further, the management server 20 determines, when it has received the request message including the address information indicating the access destination of the information terminal 30, whether or not the address information specified in the request message is a server that holds data including the confidential information. The management server 20 transmits a response message including the result of the determination to the management server 20.

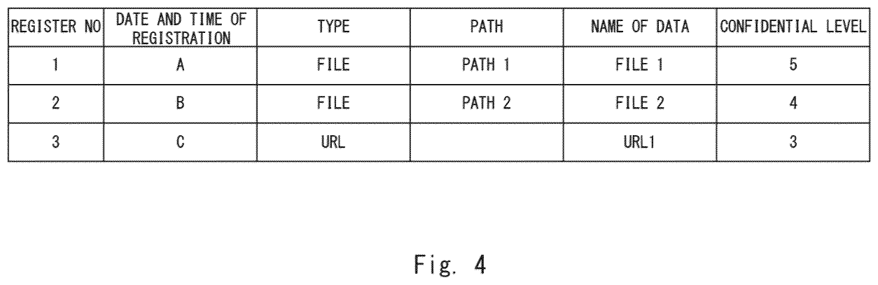

Now, with reference to FIG. 4, information stored in the data storage unit 21 indicating whether each data item includes confidential information will be described. FIG. 4 shows, of a plurality of files stored in the data storage unit 21, files including confidential information, and further indicates the access destination including confidential information. The register number (register No), which is information for uniquely identifying the stored data, is indicated using one or more integers. The date and time of registration indicates the date and time when the file or the access destination which includes the confidential information is registered in the data storage unit 21, and the date and time of registration A-B may be indicated, for example, in a form of YYYY (year) MM (month) DD (date) hh (hour) mm (minute) ss (second).

The type indicates whether the registered data is a file or URL indicating the access destination. Path 1 and path 2 indicated in a path are information indicating paths to areas where files including the confidential information are stored. The name of data indicates the name of the file including the confidential information or URL indicating the access destination to a server or the like that holds data including the confidential information.

The confidential level indicates a confidential level or an importance level of the confidential information included in each file or the data held in the server or the like of the access destination. In this example, the larger the value is, the higher the confidential level or the importance level is.

The management server 20 includes information indicating the confidential level in the response message to be transmitted to the information terminal 30.

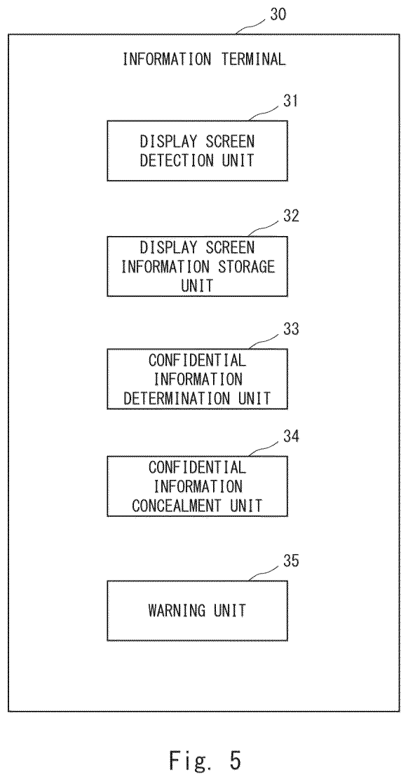

Next, with reference to FIG. 5, a configuration example of the information terminal 30 will be described. The information terminal 30 includes a display screen detection unit 31, a display screen information storage unit 32, a confidential information determination unit 33, a confidential information concealment unit 34, and a warning unit 35. The display screen detection unit 31, the display screen information storage unit 32, the confidential information determination unit 33, the confidential information concealment unit 34, and the warning unit 35 may each be software or a module whose processing is executed by a processor executing a program stored in a memory. Alternatively, the display screen detection unit 31, the display screen information storage unit 32, the confidential information determination unit 33, the confidential information concealment unit 34, and the warning unit 35 may each be hardware such as a circuit or a chip.

When the display screen detection unit 31 has acquired a file from the management server 20 by the remote operation performed in the remote operation terminal 40, the display screen detection unit 31 generates display data for displaying a file on a display apparatus. Alternatively, when the display screen detection unit 31 has acquired a file as a result of accessing a server apparatus or the like other than the information terminal 30 by a remote operation performed in the remote operation terminal 40, the display screen detection unit 31 generates display data for displaying the file on the display apparatus.

The display apparatus may be a display device that is used integrally with the information terminal 30 or may be a display device connected to the information terminal 30 via a cable or the like. The user is able to view the content of the file via a display apparatus that displays display data.

The display screen detection unit 31 outputs the generated display data to the display screen information storage unit 32. The display screen information storage unit 32 stores the received display data.

The confidential information determination unit 33 receives information indicating whether or not the display data includes confidential information transmitted from the management server 20 along with the file. Alternatively, the confidential information determination unit 33 may transmit a request message including the address information to the management server 20 when the confidential information determination unit 33 receives an instruction to access a server other than the management server 20 from the remote operation terminal 40. At this time, the confidential information determination unit 33 may receive, from the management server 20, a response message including information indicating whether or not a server or the like indicated in the address information specified in the remote operation terminal 40 holds data including confidential information.

When the confidential information determination unit 33 has received information indicating that the display data includes confidential information, the confidential information determination unit 33 outputs the result of the determination indicating that the display data stored in the display screen information storage unit 32 includes confidential information to the confidential information concealment unit 34. When the confidential information determination unit 33 has received the information indicating that the display data includes confidential information, the confidential information determination unit 33 outputs the information indicating the confidential level received from the management server 20 to the warning unit 35. Further, when the confidential information determination unit 33 has received the information indicating that the display data does not include confidential information, the confidential information determination unit 33 outputs the result of the determination indicating that the display data stored in the display screen information storage unit 32 does not include confidential information to the confidential information concealment unit 34.

When the confidential information concealment unit 34 has received the result of the determination indicating that the display data stored in the display screen information storage unit 32 includes confidential information, the confidential information concealment unit 34 conceals information displayed on the display apparatus in such a way that the display data is not displayed on the display apparatus. For example, the confidential information concealment unit 34 may output, instead of outputting the display data stored in the display screen information storage unit 32 to the display apparatus, other display data to the display apparatus. The other display data is data that does not display confidential information. The other display data may be, for example, data indicating a screen saver.

When the confidential information concealment unit 34 has received the result of the determination indicating that the display data stored in the display screen information storage unit 32 does not include confidential information, the confidential information concealment unit 34 outputs the display data stored in the display screen information storage unit 32 to the display apparatus.

The display apparatus displays display data. The remote operation terminal 40 shares the screen displayed on the display apparatus. For example, the remote operation terminal 40 may receive, from the information terminal 30, display data similar to the display data received by the display apparatus. The remote operation terminal 40 displays the received display data using the display apparatus of the remote operation terminal 40.

When the confidential information concealment unit 34 has received a message instructing that the concealment of the display data should be released, the confidential information concealment unit 34 outputs, to the display apparatus, the display data stored in the display screen information storage unit 32 in place of display data that is currently output to the display apparatus. Accordingly, the remote operation terminal 40 that shares the screen displayed on the display apparatus is able to view the confidential information.

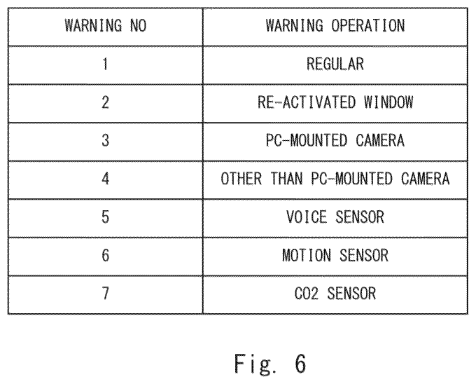

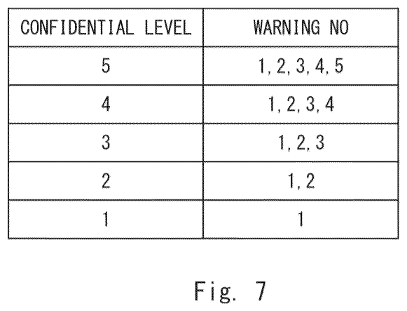

When the warning unit 35 has received the information indicating the confidential level from the confidential information determination unit 33, the warning unit 35 determines the timing when the warning message is output to the display apparatus in accordance with the confidential level. Referring now to FIGS. 6 and 7, a confidential level, and a timing when a warning message is output in accordance with the confidential level will be described. FIG. 6 shows a timing when the warning operation is performed. The warning operation may be an operation for warning the user to check the presence of a person who is peeking into the display apparatus. The warning operation may be, for example, outputting a warning message to the display apparatus. FIG. 6 shows a timing when the warning message is output to the display apparatus.

The warning number (warning No) 1 indicates regularly outputting a warning message to the display apparatus. Regarding an interval at which the warning message is output, a desired value may be set by a user or the like. For example, the warning message may be output to the display apparatus when the data including the confidential information is first displayed on the display apparatus, and after that the warning message may be regularly output to the display apparatus while the data including the confidential information is being displayed on the display apparatus.

The warning No 2 indicates outputting a warning message to the display apparatus when a window including the confidential information is non-activated after an elapse of a predetermined period of time since the data including the confidential information is first displayed and then this window is activated again. The user who has viewed the confidential information may activate the window that does not include confidential information and may non-activate the window including the confidential information. The non-activated window may be provided behind the activated window. When the user has activated the window including the confidential information in a state in which the window including the confidential information is non-activated, a third party peeking into the display apparatus can view the confidential information. In this case, the warning message is output to the display apparatus in order to warn the user.

The warning Nos 3 to No 5 each illustrate an example in which a warning image is output to the display apparatus when a person is detected by a sensor after data including the confidential information is first displayed on the display apparatus. The warning No 3 indicates that a warning message is output to the display apparatus when it is detected that an image captured by a camera mounted on a Personal Computer (PC) includes a person different from the user of the PC. The image which shows the face of the user of the PC or the user who can view the confidential information, or an image indicating features of the user may be registered in the information terminal 30 in advance.

The warning No 4 indicates outputting a warning message to the display apparatus when it is detected that an image captured by a camera other than a PC-mounted camera includes a person different from the user of the PC. The camera other than the PC-mounted camera may include, for example, a camera mounted on a smartphone terminal held by the user, or may be a camera installed in the room where the user stays. The PC-mounted camera and a camera other than the PC-mounted camera transmit the captured image to the warning unit 35.

The warning No 5 indicates outputting a warning message to the display apparatus when a voice sensor has detected a human voice. The warning No6indicates outputting a warning message to the display apparatus when a motion sensor has detected a person. The warning No7 indicates outputting a warning message to the display apparatus when a CO2 (carbon dioxide) sensor has detected carbon dioxide concentration that is equal to or greater than a predetermined concentration.

In FIG. 7, the confidential level and the warning number (warning No) are associated with each other. FIG. 7 shows, for example, that, when display data including confidential information associated with the confidential level 5 is output to the display apparatus, a warning message is output to the display apparatus at the timings of the warning Nos 1 to 5. The warning Nos are associated with the respective confidential levels 1 to 4.

The remote operation terminal 40 shares the screen displayed on the display apparatus of the information terminal 30. It is therefore possible to check the warning message displayed on the display apparatus of the information terminal 30 as well.

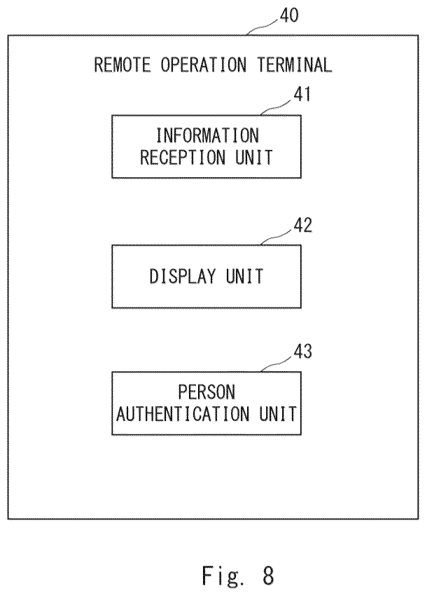

Next, with reference to FIG. 8, a configuration example of the remote operation terminal 40 according to the second example embodiment will be described. The remote operation terminal 40 includes an information reception unit 41, a display unit 42, and a person authentication unit 43. The information reception unit 41, the display unit 42, and the person authentication unit 43 may each be software or a module whose processing is executed by a processor executing a program stored in a memory. Alternatively, the information reception unit 41, the display unit 42, and the person authentication unit 43 may be each be hardware such as a circuit or a chip.

The information reception unit 41 receives an instruction to access the management server 20 or another server from the user via the input interface. The instruction to access the management server 20 may include, for example, path information indicating a path to the management server 20. The path information may indicate the place where the data is stored, and may be, for example, information indicating the directory where the data is saved. Alternatively, the instruction to access the management server 20 may include URL, which is address information of the server connected to the information terminal 30 via the Internet.

The display unit 42 displays display data received from the information terminal 30. The display unit 42 may be, for example, a display device that is used integrally with the remote operation terminal 40. Alternatively, the display unit 42 may display the display data on the display device connected to the remote operation terminal 40 via a cable or the like.

Here, the display data including confidential information may be concealed on the display unit 42. For example, a screen of a screen saver may be displayed on the display unit 42. For example, the display unit 42 conceals the display data when the place where the data is stored or address information included in the access instruction input from the user matches the place where the data including the confidential information is stored or the address information of the data including the confidential information. In this case, the person authentication unit 43 receives the identification information on the user via the information reception unit 41 and determines whether or not the identification information on the user matches identification information registered in advance. For example, the identification information of the user who can operate the remote operation terminal 40 may be registered in the remote operation terminal 40 in advance. The person authentication unit 43 outputs the result of the determination to the information reception unit 41. The display unit 42 may display, for example, a screen for enabling the identification information on the user to be input on the screen of the screen saver. That is, when the display data includes confidential information and thus the display data is concealed, the display unit 42 may display a screen for enabling the identification information on the user to be input.

When the information reception unit 41 has received the result of the determination indicating that the identification information on the user matches the identification information registered in advance, the information reception unit 41 transmits, to the information terminal 30, a message instructing that the concealment of the display data should be released. That is, the information terminal 30 conceals the display data until it receives the result of the determination indicating that the identification information on the user matches the identification information registered in advance. When the information terminal 30 receives a message for instructing that the concealment of the display data should be released, the information terminal 30 displays display data including confidential information. In accordance therewith, the display unit 42 also displays display data including confidential data.

Further, the display unit 42 displays the warning message displayed on the display apparatus of the information terminal 30 as well by sharing the screen displayed on the display apparatus of the information terminal 30. The user who operates the information terminal 30 is able to check if there is a person who is peeking into the display unit 42 nearby by checking the warning message.

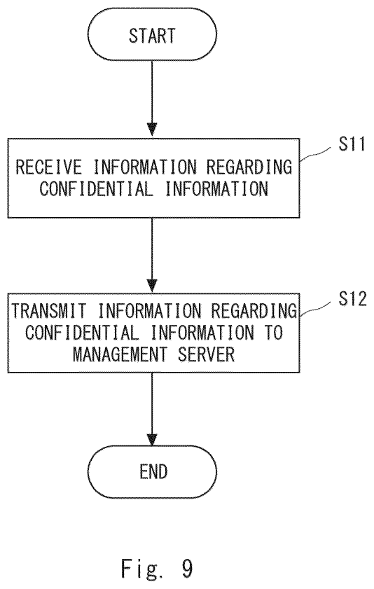

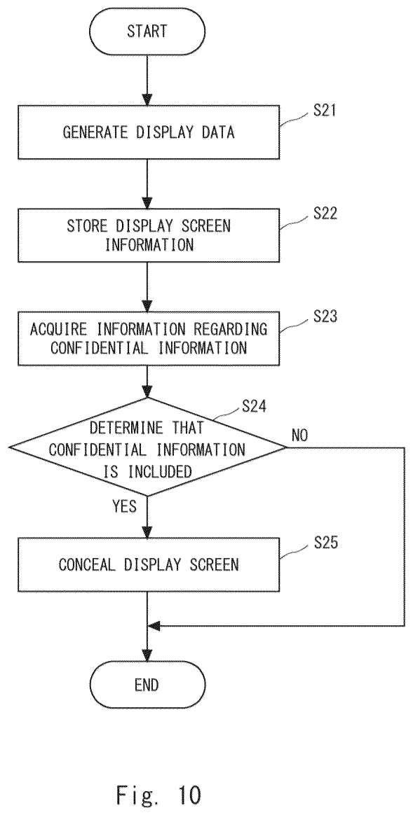

Next, with reference to FIG. 9, a flow of processing for registering information regarding the confidential information in the management server 20 will be described. First, the information terminal 30 receives the information regarding the confidential information (S11). The information terminal 30 may receive information regarding the confidential information input from the user who operates the information terminal 30 or may receive the information regarding the confidential information transmitted from the remote operation terminal 40.

The information regarding the confidential information may include, for example, the name of the data and the confidential level as shown in FIG. 4. Further, the information regarding the confidential information may include a file identified by the name of the data. Next, the information terminal 30 transmits the information regarding the confidential information to the management server 20 (S12). Upon receiving the information regarding the confidential information, the management server 20 manages the received information as shown in FIG. 4.

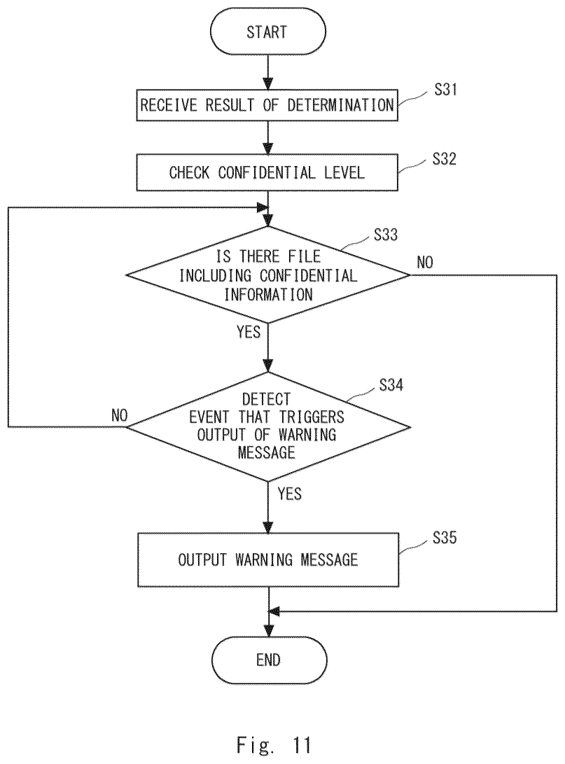

Next, with reference to FIG. 10, a flow of processing of concealing the screen including the confidential data will be described. First, the display screen detection unit 31 generates display data for displaying the file acquired by the remote operation performed in the remote operation terminal 40 on the display apparatus (S21). The display screen detection unit 31 acquires the file from the management server 20 or a server other than the management server 20.

Next, the display screen information storage unit 32 stores the display data generated in the display screen detection unit 31 (S22).

Next, the confidential information determination unit 33 receives information indicating whether or not the received file includes confidential information (S23). The information indicating whether or not the received file includes the confidential information may be received from the information terminal 30 along with the file. Alternatively, the information indicating whether or not the received file includes the confidential information may be transmitted from the management server 20 along with a response message when a request message including the address information is transmitted from the confidential information determination unit 33 to the management server 20.

Next, the confidential information determination unit 33 determines whether or not the received file includes confidential information (S24). When it is determined in the confidential information determination unit 33 that the display data includes the confidential information, the confidential information concealment unit 34 conceals the display data in such a way that the display data is not displayed on the display apparatus (S25). For example, the confidential information concealment unit 34 may output, instead of outputting the display data stored in the display screen information storage unit 32 to the display apparatus, other display data to the display apparatus. When it is determined in the confidential information determination unit 33 that the display data does not include confidential information, processing regarding concealment of the confidential information is not performed.

Next, with reference to FIG. 11, a flow of processing for outputting the warning message will be described. First, the warning unit 35 receives, from the confidential information determination unit 33, the result of the determination indicating that the display data includes confidential information and information indicating the confidential level of the confidential information (S31). Next, the warning unit 35 checks the confidential level (S32). The warning unit 35 checks the confidential level in order to determine the timing when the warning message is to be output.

Next, the warning unit 35 determines whether or not there is a file including confidential information in the display data (S33). For example, when the user of the remote operation terminal 40 has performed an operation of canceling the display of the confidential information after viewing the confidential information, the file including the confidential information no longer exists in the display data. On the other hand, when the user of the remote operation terminal 40 does not perform an operation of canceling the display of the confidential information after viewing the confidential information, the file including the confidential information exists in the display data.

When it is determined that there is a file including confidential information in the display data, the warning unit 35 determines whether or not an event that triggers output of a warning message associated with the confidential level is occurring (S34). For example, when the confidential level is 5, the warning unit 35 determines whether or not one of the warning Nos 1 to 5 shown in FIG. 6 is occurring.

When it is determined that an event that triggers output of a warning message is occurring, the warning unit 35 outputs a warning message to the display apparatus (S35).

When it is determined in Step S33 that there is no file including confidential information in the display data, the processing is ended. Further, when it is determined in Step S34 that an event that triggers output of a warning message associated with the confidential level has not occurred, the processing of Step S33 and the following processing are repeated.

As described above, in the monitoring system according to the second example embodiment, the processing is executed in such a way that a warning message can be checked on the remote operation terminal in accordance with the confidential level of the confidential information when the confidential information is viewed on the remote operation terminal. Specifically, as the confidential level is higher, the warning message is output more frequently. That is, as the confidential level is lower, the warning message is output less frequently than that in the case where the confidential level is higher. Accordingly, the monitoring system can efficiently output the warning message, and the number of messages for outputting the warning message is increased when the confidential level is high, whereby robust security can be achieved.

Note that the function sharing between the information terminal 30 in FIG. 5 and the remote operation terminal 40 in FIG. 8 is merely one example and function sharing other than that shown in FIGS. 5 and 8 may be performed. For example, the information terminal 30 may determine whether or not the file includes confidential information, and the remote operation terminal 40 may perform generation of the display data, concealment of the display data, output of the warning message, and determination of the timing when the warning message is output. That is, the information terminal 30 may include the confidential information determination unit 33, and the remote operation terminal 40 may include a display screen detection unit 31, a display screen information storage unit 32, a confidential information concealment unit 34, and a warning unit 35.

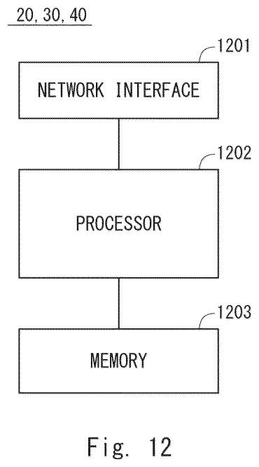

FIG. 12 is a block diagram showing a configuration example of the management server 20, the information terminal 30, and the remote operation terminal 40 (hereinafter, they are referred to as the information terminal 30 and so on) described in the above-described example embodiments. Referring to FIG. 12, the information terminal 30 and so on include a network interface 1201, a processor 1202, and a memory 1203. The network interface 1201 may be used to communicate with a network node. The network interface 1201 may include, for example, a network interface card (NIC) in compliance with the IEEE 802.3 series. IEEE stands for Institute of Electrical and Electronics Engineers.

The processor 1202 loads software (a computer program) from the memory 1203 and executes this loaded software, thereby performing processing of the control apparatus 30 and so on described with reference to the flowchart in the above-described example embodiments. The processor 1202 may be, for example, a microprocessor, an MPU, or a CPU. The processor 1202 may include a plurality of processors.

The memory 1203 is composed of a combination of a volatile memory and a non-volatile memory. The memory 1203 may include a storage located apart from the processor 1202. In this case, the processor 1202 may access the memory 1203 via an Input/Output (I/O) interface (not shown).

In the example shown in FIG. 12, the memory 1203 is used to store software modules. The processor 1202 loads these software modules from the memory 1203 and executes these loaded software modules, thereby performing processing of the information terminal 30 and so on described in the aforementioned example embodiments.

As described with reference to FIG. 12, each of the processors included in the information terminal 30 and so on according to the above-described example embodiments executes one or more programs including instructions for causing a computer to execute the algorithm described with reference to the drawings.

In the aforementioned examples, the program includes instructions (or software codes) that, when loaded into a computer, cause the computer to perform one or more of the functions described in the example embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Note that the present disclosure is not limited to the above-described example embodiments and may be changed as appropriate without departing from the scope of the present disclosure.

The whole or part of the example embodiments disclosed above can be described as, but not limited to, the following supplementary notes.

### Supplementary Note 1

A monitoring system comprising:
reception means for receiving an instruction to access data including confidential information and identification information that is used to identify a user who uses the data:
display means for displaying the data when the input identification information on the user matches identification information associated with a user who is permitted to view the data: and
execution means for performing security processing in accordance with a confidential level associated with the data in advance while the data is being displayed on the display means.

### Supplementary Note 2

The monitoring system according to Supplementary Note 1, wherein the execution means is configured to change a timing when a warning operation is executed in accordance with the confidential level associated with the data in advance.

### Supplementary Note 3

The monitoring system according to Supplementary Note 2, wherein the execution means is configured to output a warning message when the data is first displayed and regularly outputs the warning message while the data is being displayed.

### Supplementary Note 4

The monitoring system according to Supplementary Note 2 or 3, wherein the execution means is configured to output a warning message when the data that has been non-activated is activated after an elapse of a predetermined period of time since the data was first displayed.

### Supplementary Note 5

The monitoring system according to Supplementary Note 3 or 4, wherein the execution means is configured to output the warning message in a case where a person has been detected by a sensor after the data is first displayed.

### Supplementary Note 6

The monitoring system according to Supplementary Note 5, wherein the sensor is at least one of a camera, a voice sensor, a motion sensor, or a carbon dioxide detection sensor.

### Supplementary Note 7

The monitoring system according to any one of Supplementary Notes 1 to 6, wherein the display means is configured to display a screen for enabling the identification information to be input when a place where the data is stored or address information of the data matches predetermined information.

### Supplementary Note 8

The monitoring system according to any one of Supplementary Notes 1 to 7, wherein the display means is configured to conceal the data until when it is determined that the identification information matches the identification information associated with the user who is permitted to view the data.

### Supplementary Note 9

A communication apparatus comprising:
reception means for receiving an instruction to access data and identification information that is used to identify a user who uses the data:
determination means for determining whether or not the data is confidential information:
display means for displaying the data when it is determined that the data is the identification information and the identification information matches identification information associated with the user who is permitted to view the data; and
execution means for performing security processing in accordance with a confidential level associated with the data in advance while the data is being displayed.

### Supplementary Note 10

The communication apparatus according to Supplementary Note 9, wherein the execution means is configured to change a timing when a warning operation is executed in accordance with the confidential level associated with the data in advance.

### Supplementary Note 11

The communication apparatus according to Supplementary Note 10, wherein the execution means is configured to output a warning message when the data is first displayed and regularly outputs the warning message while the data is being displayed.

### Supplementary Note 12

The communication apparatus according to Supplementary Note 10 or 11, wherein the execution means is configured to output a warning message when the data that has been non-activated is activated after an elapse of a predetermined period of time since the data was first displayed.

### Supplementary Note 13

The communication apparatus according to Supplementary Note 11 or 12, wherein the execution means is configured to output the warning message in a case where a person has been detected by a sensor after the data is first displayed.

### Supplementary Note 14

A communication apparatus comprising:
reception means for receiving an instruction to access data: and
display means for displaying display data similar to display data displayed on a display apparatus of an information terminal,
wherein the display means displays, when the data is confidential information, a warning message and the timing of displaying the warning message on the display apparatus of the information terminal is varied in accordance with a confidential level associated with the data.

### Supplementary Note 15

The communication apparatus according to Supplementary Note 14, wherein the display means is configured to receive the display data transmitted from the information terminal and displays the received display data.

### Supplementary Note 16

A monitoring method comprising:
receiving an instruction to access data:
determining whether or not the data is confidential information;
receiving, in a case where the data is the confidential information, identification information for identifying a user who uses the data:
displaying the data in a case where the input identification information on the user matches identification information associated with a user who is allowed to view the data: and
performing security processing in accordance with a confidential level associated with the data in advance while the data is being displayed.

### Supplementary Note 17

A non-transitory computer readable medium storing a program for causing a computer to execute:
receiving an instruction to access data:
determining whether or not the data is confidential information:
receiving, in a case where the data is the confidential information, identification information for identifying a user who uses the data:
displaying the data in a case where the input identification information on the user matches identification information associated with a user who is allowed to view the data; and
performing security processing in accordance with a confidential level associated with the data in advance while the data is being displayed.

### REFERENCE SIGNS LIST

11 RECEPTION MEANS
12 DISPLAY MEANS
13 EXECUTION MEANS
20 MANAGEMENT SERVER
21 DATA STORAGE UNIT
30 INFORMATION TERMINAL
31 DISPLAY SCREEN DETECTION UNIT
32 DISPLAY SCREEN INFORMATION STORAGE UNIT
33 CONFIDENTIAL INFORMATION DETERMINATION UNIT
34 CONFIDENTIAL INFORMATION CONCEALMENT UNIT
35 WARNING UNIT
40 REMOTE OPERATION TERMINAL
41 INFORMATION RECEPTION UNIT
42 DISPLAY UNIT
43 PERSON AUTHENTICATION UNIT
50 INFORMATION TERMINAL
60 REMOTE OPERATION TERMINAL

What is claimed is:

1. A monitoring system comprising:
at least one memory storing instructions, and
at least one processor configured to execute the instructions to;
receive an instruction to access data including confidential information and identification information that is used to identify a user who uses the data;
display the data when the input identification information on the user matches identification information associated with a user who is permitted to view the data; and
perform security processing in accordance with a confidential level associated with the data in advance while the data is being displayed.

2. The monitoring system according to claim 1, wherein the at least one processor is further configured to execute the instructions to the execution means is configured to change a timing when a warning operation is executed in accordance with the confidential level associated with the data in advance.

3. The monitoring system according to claim 2, wherein the at least one processor is further configured to execute the instructions to output a warning message when the data is first displayed and regularly outputs the warning message while the data is being displayed.

4. The monitoring system according to claim 2, wherein the at least one processor is further configured to execute the instructions to output a warning message when the data that has been non-activated is activated after an elapse of a predetermined period of time since the data was first displayed.

5. The monitoring system according to claim 3, wherein the at least one processor is further configured to execute the instructions to output the warning message in a case where a person has been detected by a sensor after the data is first displayed.

6. The monitoring system according to claim 5, wherein the sensor is at least one of a camera, a voice sensor, a motion sensor, or a carbon dioxide detection sensor.

7. The monitoring system according to claim 1, wherein the at least one processor is further configured to execute the instructions to display a screen for enabling the identification information to be input when a place where the data is stored or address information of the data matches predetermined information.

8. The monitoring system according to claim 1, wherein the at least one processor is further configured to execute the instructions to conceal the data until when it is determined that the identification information matches the identification information associated with the user who is permitted to view the data.

9. A communication apparatus comprising:
at least one memory storing instructions, and
at least one processor configured to execute the instructions to;
receive an instruction to access data and identification information that is used to identify a user who uses the data;
determine whether or not the data is confidential information;
display the data when it is determined that the data is the identification information and the identification information matches identification information associated with the user who is permitted to view the data; and
perform security processing in accordance with a confidential level associated with the data in advance while the data is being displayed.

10. The communication apparatus according to claim 9, wherein the at least one processor is further configured to execute the instructions to change a timing when a warning operation is executed in accordance with the confidential level associated with the data in advance.

11. The communication apparatus according to claim 10, wherein the at least one processor is further configured to execute the instructions to output a warning message when the data is first displayed and regularly outputs the warning message while the data is being displayed.

12. The communication apparatus according to claim 10, wherein the at least one processor is further configured to execute the instructions to output a warning message when the data that has been non-activated is activated after an elapse of a predetermined period of time since the data was first displayed.

13. The communication apparatus according to claim 11, wherein the at least one processor is further configured to execute the instructions to output the warning message in a case where a person has been detected by a sensor after the data is first displayed.

14. A communication apparatus comprising:
at least one memory storing instructions, and
at least one processor configured to execute the instructions to;
receive an instruction to access data; and
display display data similar to display data displayed on a display apparatus of an information terminal,
display, when the data is confidential information, a warning message, the timing of displaying the warning message on the display apparatus of the information terminal being varied in accordance with a confidential level associated with the data.

15. The communication apparatus according to claim 14, wherein the at least one processor is further configured to execute the instructions to receive the display data transmitted from the information terminal and displays the received display data.

16. A monitoring method comprising:
receiving an instruction to access data;
determining whether or not the data is confidential information;
receiving, in a case where the data is the confidential information, identification information for identifying a user who uses the data;
displaying the data in a case where the input identification information on the user matches identification information associated with a user who is allowed to view the data; and
performing security processing in accordance with a confidential level associated with the data in advance while the data is being displayed.

17. (canceled)
